(19) United States
(12) Patent Application Publication
(10) Pub. No.: US 2024/0279913 A1
(43) Pub. Date: Aug. 22, 2024

(54) INDOOR WATER LEAK DETECTION AND TYPE IDENTIFICATION DEVICE AND METHOD USING MULTIDIMENSIONAL DATA

(71) Applicant: TOICOS INC., Sejong-si (KR)

(72) Inventor: Junseok EOM, Sejong-si (KR)

(73) Assignee: TOICOS INC., Sejong-si (KR)

(21) Appl. No.: 18/650,776

(22) Filed: Apr. 30, 2024

Related U.S. Application Data
(63) Continuation of application No. PCT/KR2021/017878, filed on Nov. 30, 2021.

(30) Foreign Application Priority Data
Nov. 2, 2021 (KR) 10-2021-0148464

(51) Int. Cl. E03B 7/00; G01D 4/00

(52) U.S. Cl. CPC E03B 7/003; G01D 4/002; G01D 2204/22

(57) ABSTRACT

Disclosed are a device and a method for indoor water leak detection and type identification using multidimensional data that may receive water usage data and multidimensional data regarding water leak occurrence and perform use machine learning to analyze an indoor water leak period in detail, and may repeatedly perform an error verification procedure to determine whether actual water leaks are predicted by a learning model, thereby improving the accuracy of indoor water leak detection and type identification.

### CROSS-REFERENCE TO RELATED APPLICATIONS

The present application is a continuation of International Patent Application No. PCT/KR2021/017878, filed on Nov. 30, 2021, which is based upon and claims the benefit of priority to Korean Patent Application No. 10-2021-0148464 filed on Nov. 2, 2021. The disclosures of the above-listed applications are hereby incorporated by reference herein in their entirety.

### BACKGROUND

Embodiments of the present disclosure described herein relate to an indoor water leak detection and type identification device that detects indoor water leaks by analyzing multidimensional data such as time unit water usage data, consumer information, and facility information, which are collected by a smart water metering system, and classifies the type thereof, and a method thereof, and a program, and more particularly, relate to an indoor water leak detection and type identification device using multidimensional data capable of accurately detecting indoor water leaks and identifying a water leak type by performing deep learning of one-dimensional data on water usage data stored in the smart water metering system, and matching caliber-specific water leak occurrence and a water leak type to perform machine learning in the Nth order in consideration of multidimensional data regarding the occurrence of indoor water leaks and type identification, and a method thereof, and a program.

Generally, water pipes for water supply are buried underground in houses, stores, factories, and apartments. A plurality of water pipes are connected like a network to form a water pipe network.

People usually desire to be supplied with clean water, and thus water utilities periodically replace old water pipes. Sometimes, water pipe replacement is not done properly.

In this way, when the old water pipes are not properly replaced, not only a large amount of water may be wasted, but the water quality may also be polluted due to the inflow of foreign substances.

Accordingly, to replace and repair water leak pipes, water leak detection technology has been developed to detect locations of water leaks.

Previously, a listening device has been used to detect water leaks by listening to the sound flowing through water pipes.

However, this method is not easy to detect water leaks when water pipes are buried deep in the ground or when ambient noise occurs.

Moreover, as sensor technology has recently developed, monitoring systems are becoming widely available to sense various pieces of information generated in water pipes by using sensors and to identify events occurring in water pipes based on the various pieces of information.

In this regard, it is determined whether a water leak has occurred in a specific water pipe among a plurality of water pipes, by placing predetermined water leak detection sensors on the plurality of water pipes in the water pipe network. When a water leak occurs in the specific water pipe, a remote meter reading system has been introduced to notify managers of location information of the specific water pipe.

Furthermore, a main pipe of the water supply pipe is buried near the corresponding destination, and the main pipe is connected to the final destination through each necessary branch pipe.

A target provided through these water supply pipes is fluid water. The final destination is equipped with a meter for measuring the usage amount of fluid. Nowadays, meters equipped with remote meter reading means are being installed such that meter readers may check usage from a distance without having to go directly to the meter at the final destination.

This remote meter reading improves problems with a monthly meter reading method by meter readers, thereby reducing the time and labor costs required for meter reading, and predicting the demand for the corresponding pipeline through accumulated data at the same time. Moreover, safety accidents may be prevented because the remote meter reading is used in environments where meter readers have difficulty accessing the meter, such as in a location with frequent traffic, buried in the ground, or placed on the ceiling.

In the meantime, there may be a difference between the amount of water supplied through the water supply pipe and the consumer's water usage calculated through meter reading. There are various causes that cause the difference.

One of the important causes is water leakage due to damage to the water supply pipe due to aging, poor connection at the joint, or poor welding at the joint.

Here, water leaks caused by pipe rupture, and deteriorated pipe joints are defined as “water leak amount”. The amount of water in the pipe, the amount of water used in water purification plants or water supply facilities, public water quantity and meters, and metering under-registration due to meter error are defined as “non-revenue water”.

Conventional methods for calculating water leak amount include an integrated flow rate approach and a minimum flow rate approach.

The integrated flow rate approach refers to a method of calculating a difference between the supply quantity and the effective water as the water leak amount by considering a water supply amount and a meter reading measurement amount in a specific time period as effective water. The minimum flow rate approach refers to a method of calculating the measured value for each block as the water leak amount in the middle of the night, assuming that consumers do not use a water supply.

It is difficult to accurately calculate the actual water leak amount through these methods. The calculation method itself has many inferences. These methods are performed manually. Accordingly, there were limits to the practical use of the methods.

It is necessary for both suppliers and users to accurately determine whether water leaks occur in water supply pipes, and the amount of water leaks. When the amount of water leak increases and ground subsidence occurs at that point, it may lead to a major accident or require large-scale replacement of the pipe. Accordingly, it is very important to identify water leaks in the shortest time.

In the meantime, water leaks indoors in addition to water supply pipes include a variety of causes such as water leaks caused by bursting of water pipes installed indoors, water leaks due to not turning off faucets, or water leaks from a toilet bowl in a bathroom.

The conventional methods for checking for indoor water leaks due to the causes of indoor water leaks are as follows. A method for checking indoor water leaks when direct water is used without using a water tank may determine that there is a water leak when a red star on a water meter turns on even though water is not used in the house during a water supply period.

Moreover, a method for checking for water leaks in a pipe from a water meter to a water tank may determine that there is a water leak between the meter and the water tank when the red star on the water meter turns on even though an inlet valve in a rooftop water tank is closed during the water supply period, in the case where tap water is used from a rooftop water tank.

Furthermore, a method for checking for water leaks in a pipe from the rooftop water tank to the faucet may determine that there is a water leak in the pipe after the water tank when the inlet valve in the rooftop water tank is closed and the water in the water tank decreases even though water is not used in the house, in the case where tap water is used from a rooftop water tank.

However, the conventional method of checking for indoor water leaks requires residents of water supply consumers to individually self-read water meters and check for indoor water leaks by comparing the checked usage with their usual usage.

Besides, even though indoor water use is in a normal state, it may be falsely detected as an indoor water leak state. Even though is an indoor water leak state, it may be falsely detected as a normal state.

In the meantime, artificial Intelligence (AI) is the study of mimicking the human brain and neural networks of neurons such that computers or robots may think and act like humans one day.

For example, people may easily distinguish a dog from a cat from a photo, but a computer may not distinguish between them.

To this end, a “machine learning (ML)” technique was invented. This technique refers to a technique that inputs a lot of data into a computer and classifies similar items. When a photo similar to a stored dog photo is input, the computer classifies it as a dog photo.

Depending on a method of classifying data, many machine learning algorithms have emerged, including decision trees, Bayesian networks, support vector machines (SVMs), and artificial neural networks.

Among the machine learning algorithms, deep learning (DL), which is derived from artificial neural network algorithms, is a technique used to cluster or classify data by using artificial neural networks.

An artificial neural network in machine learning and cognitive science is a statistical learning algorithm inspired by neural networks in biology (the central nervous system of animals).

An artificial neural network refers to a model, in which artificial neurons, which form a network by the coupling of their synapses, change the coupling strength of the synapses through learning and have the ability to solve problems.

The core of deep learning using artificial neural networks is prediction through classification.

Computers categorize data as if humans categorize objects by discovering patterns in a large amount of data.

This categorization method includes supervised learning (supervisor/teacher) optimized for the problem by inputting signals (correct answers) from a leader (supervisor/teacher), and unsupervised learning (supervisor/teacher) that does not require supervised signals from the leader.

Because it is generally expressed as an interconnection of a neuron system that calculates values from input and is adaptive, machine learning, such as pattern recognition, may be performed.

Like other machine learning methods that learn from data, the neural networks are used to solve a wide range of problems, such as image recognition or speech recognition, that are typically difficult to solve with rule-based programming.

In other words, various machine learning techniques include random forest, which outputs classes (classification) or average predicted values (regression analysis) from a plurality of decision trees constructed during a training process, extreme gradient boosting (XGBoost), which creates a strong learner by sequentially adding predictors to compensate for previous errors, and LASSO Regression that sets the weight to ‘0’ by using the absolute value of a regression coefficient as a penalty term, and are being applied to fields such as image recognition. Accordingly, machine learning techniques with excellent performance are being developed.

Accordingly, the present inventors may have come to invent an indoor water leak detection and type identification device using multidimensional data, and a method thereof to receive water usage data and multidimensional data regarding water leak occurrence to recognize a pattern image of water usage by using a machine learning technique, to analyze an indoor water leak period, a water leak type, and a water leak amount in detail, and to accurately provide indoor water leak detection and type identification information without detection through various conventional sensors even when a normal state and an indoor water leak state are falsely detected.

### SUMMARY

Embodiments of the present disclosure provide an indoor water leak detection and type identification device using multidimensional data that may receive water usage data and multidimensional data regarding water leak occurrence and perform use machine learning to analyze an indoor water leak period in detail, and may repeatedly perform an error verification procedure to determine whether actual water leaks are predicted by a learning model, thereby improving the accuracy of indoor water leak detection and type identification.

Embodiments of the present disclosure provide an indoor water leak detection and type identification method using multidimensional data to achieve the task.

Problems to be solved by the present disclosure are not limited to the problems mentioned above, and other problems not mentioned will be clearly understood by those skilled in the art from the following description.

According to an embodiment, an indoor water leak detection and type identification device using multidimensional data includes a metering data collection unit that collects water usage data measured from a water meter for remote meter reading, a controller that receives the measured water usage data, calculates first and second measured time intervals of minimum water usage for each customer, generates combination data of ‘normal state’ and ‘indoor water leak state’, and performs identification of a water leak type and calculation of a water leak amount when the ‘indoor water leak state’ is detected, a normal use machine learning unit that receives data preprocessed on the water usage data in a form of a plurality of input vectors, and performs first machine learning by performing a convolution operation on a bias, an ensemble machine learning unit that receives water usage data labeled as the ‘indoor water leak state’ and multidimensional data on water leak occurrence, and perform seconds machine learning by matching caliber-specific water leak occurrence and the water leak type. The controller classifies data on the calculated time intervals into the ‘normal state’ or the ‘indoor water leak state’ by determining whether a first time of the data on the calculated time intervals is exceeded, preprocesses a missing value, a negative value, and an abnormal value among the collected water usage data, and removes the preprocessed missing value, the preprocessed negative value, and the preprocessed abnormal value from a water leak detection target and a type identification target. The water leak detection target includes a toilet, a pipe rupture, an anti-freezing faucet, a boiler, a water purifier, and a pot waterer. The ensemble machine learning unit classifies a type of a learning model by using a confusion matrix based on a random forest algorithm. The type of the learning model is classified into the toilet, the pipe rupture, the anti-freezing faucet, the boiler, the water purifier, and the pot waterer. The toilet, the pipe rupture, and the anti-freezing faucet are again classified through a slope of a trend line of water usage within a water leak period. The type of the learning model is classified as the toilet when the slope of the trend line is within ±0.2. The type of the learning model is classified as the pipe rupture when the slope of the trend line is greater than or equal to 0.2. The type of the learning model is classified as the anti-freezing faucet when the slope of the trend line is smaller than or equal to 0.2.

According to an embodiment, an indoor water leak detection and type identification method using multidimensional data includes receiving, by a controller of a device, water usage data measured through remote meter reading, calculating first and second measured time intervals of minimum water usage for each consumer, and performing, by a normal use machine learning unit, first machine learning on the water usage data, labeling, by the controller, result data, which is obtained by performing the first machine learning, as ‘indoor water leak state’ in a case of water leak occurrence based on sizes of the calculated time intervals, receiving, by an ensemble machine learning unit, multidimensional data on the water leak occurrence, and performing second machine learning, and generating, by the controller, combination data of ‘normal state’ and the ‘indoor water leak state’, and performing identification of a water leak type and calculation of a water leak amount when the ‘indoor water leak state’ is detected. The performing of the first machine learning includes calculating, by the controller, the first and second measured time intervals of the minimum water usage for each consumer, determining, by the controller, whether the first time of data on the calculated time intervals is exceeded, and classifying, by the controller, the data as the ‘normal state’ or the ‘indoor water leak state’ based on whether the first time is exceeded. The controller classifies data on the calculated time intervals into the ‘normal state’ or the ‘indoor water leak state’ by determining whether a first time of the data on the calculated time intervals is exceeded, preprocesses a missing value, a negative value, and an abnormal value among the collected water usage data, and removes the preprocessed missing value, the preprocessed negative value, and the preprocessed abnormal value from a water leak detection target and a type identification target. The water leak detection target includes a toilet, a pipe rupture, an anti-freezing faucet, a boiler, a water purifier, and a pot waterer. The ensemble machine learning unit classifies a type of a learning model by using a confusion matrix based on a random forest algorithm. The type of the learning model is classified into the toilet, the pipe rupture, the anti-freezing faucet, the boiler, the water purifier, and the pot waterer. The toilet, the pipe rupture, and the anti-freezing faucet are again classified through a slope of a trend line of water usage within a water leak period. The type of the learning model is classified as the toilet when the slope of the trend line is within ±0.2. The type of the learning model is classified as the pipe rupture when the slope of the trend line is greater than or equal to 0.2. The type of the learning model is classified as the anti-freezing faucet when the slope of the trend line is smaller than or equal to 0.2.

Other details according to an embodiment of the present disclosure are included in the detailed description and drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram of an indoor water leak detection and type identification device using multidimensional data, according to an embodiment of the present disclosure;

FIG. 2 is a flowchart for describing overall operations of an indoor water leak detection and type identification method using multidimensional data, according to an embodiment of the present disclosure;

FIG. 3 is a flowchart for describing a detailed operation of step S100 of the indoor water leak detection and type identification method shown in FIG. 2;

FIG. 4 is a configuration diagram for describing a detailed operation of step S130 of the indoor water leak detection and type identification method shown in FIG. 3;

FIG. 5 is a flowchart for describing a detailed operation of step S200 of the indoor water leak detection and type identification method shown in FIG. 2;

FIG. 6 is a flowchart for describing a detailed operation of step S260 of the indoor water leak detection and type identification method shown in FIG. 5;

FIG. 7 is a flowchart for describing a detailed operation of step S300 of the indoor water leak detection and type identification method shown in FIG. 2;

FIG. 8 is a graph according to a measurement date and time of water usage data collected by a metering data collection unit in step S110 of the indoor water leak detection and type identification method shown in FIG. 3;

FIGS. 9A and 9B are graphs according to a measurement date and time of data (a) of normal state and data (b) of indoor water leak state classified by a controller in step S150 of the indoor water leak detection and type identification method shown in FIG. 3;

FIG. 10 is a table of data labeled according to whether there is an indoor water leak determined by a controller in step S150 of the indoor water leak detection and type identification method shown in FIG. 5;

FIGS. 11 to 13 are graphs according to a measurement date and time of water usage data of water leak types classified by a controller in step S300 of the indoor water leak detection and type identification method shown in FIG. 2; and

FIGS. 14 to 16 are graphs of water usage data compared to a water leak period of water leak types classified by a controller in step S300 of the indoor water leak detection and type identification method shown in FIG. 2.

### DETAILED DESCRIPTION

The above and other aspects, features and advantages of the present disclosure will become apparent from embodiments to be described in detail in conjunction with the accompanying drawings.

The present disclosure, however, may be embodied in various different forms, and should not be construed as being limited only to the illustrated embodiments. Rather, these embodiments are provided as examples so that the present disclosure will be thorough and complete, and will fully convey the scope of the present disclosure to those skilled in the art. The present disclosure may be defined by the scope of the claims.

The terms used herein are provided to describe embodiments, not intended to limit the present disclosure. In the specification, the singular forms include plural forms unless particularly mentioned. The terms “comprises” and/or “comprising” used herein do not exclude the presence or addition of one or more other components, in addition to the aforementioned components. The same reference numerals denote the same components throughout the specification. As used herein, the term “and/or” includes each of the associated components and all combinations of one or more of the associated components. It will be understood that, although the terms “first”, “second”, etc., may be used herein to describe various components, these components should not be limited by these terms. These terms are only used to distinguish one component from another component. Thus, a first component that is discussed below could be termed a second component without departing from the technical idea of the present disclosure.

Unless otherwise defined, all terms (including technical and scientific terms) used herein have the same meaning as commonly understood by those skilled in the art to which the present disclosure pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

As illustrated in the figures, spatially relative terms, such as “below”, “beneath”, “lower”, “above”, “upper”, and the like, may be used herein for ease of description to describe the relationship between one component and other components. It will be understood that the spatially relative terms are intended to encompass different orientations of the components in use or operation in addition to the orientation depicted in the figures. For example, when inverting a component shown in the figures, a component described as “below” or “beneath” of another component may be placed “above” another element. Thus, the term “below” may include both downward and upward directions. The components may also be oriented in different directions, and thus the spatially relative terms may be interpreted depending on orientation.

In the present disclosure, the second machine learning of an ensemble machine learning unit is expressed as ‘second’ as an example for convenience of understanding to distinguish the second machine learning from the first machine learning of a normal use machine learning unit. Because the ensemble machine learning unit receives and processes multidimensional data (N-dimensional data), the second machine learning may mean N-th machine learning.

Hereinafter, embodiments of the present disclosure will be described in detail with reference to accompanying drawings.

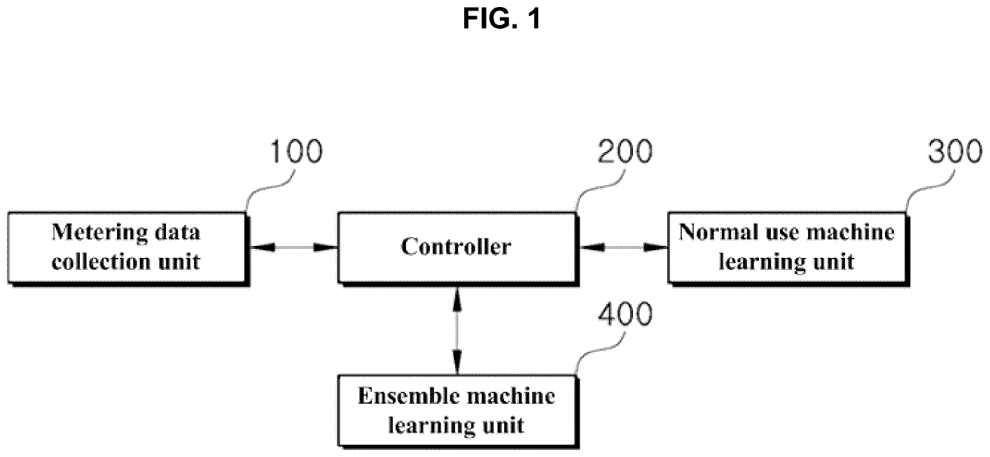

FIG. 1 is a block diagram of an indoor water leak detection and type identification device using multidimensional data according to an embodiment of the present disclosure, and includes a metering data collection unit 100, a controller 200, a normal use machine learning unit 300, and an ensemble machine learning unit 400.

The functions of components of an indoor water leak detection and type identification device using multidimensional data according to an embodiment of the present disclosure are briefly described with reference to FIG. 1 as follows.

The metering data collection unit 100 collects water usage data measured from a water meter for remote meter reading.

The controller 200 receives water usage data measured from a water meter for remote meter reading, calculates the first and second measured time intervals of minimum water usage for each customer, and generates combination data of ‘normal state’ and ‘indoor water leak state’. When ‘indoor water leak state’ is detected, the controller 200 identifies a water leak type and calculates water leak amount.

Moreover, the controller 200 classifies the calculated time interval data into ‘normal state’ or ‘indoor water leak state’ by determining whether a first time of the calculated time interval data is exceeded, and determines whether there is an indoor water leak after first machine learning (i.e. deep learning) in the normal use machine learning unit 300. When it is determined that the indoor water leak is present, the controller 200 labels the result data, which is obtained by performing the first machine learning, as ‘indoor water leak state’ and outputs the measured water usage data. When it is determined that there is no indoor water leak, the controller 200 labels the result data as ‘normal state’.

The normal use machine learning unit 300 receives data preprocessed on the water usage data in a form of a plurality of input vectors, and performs first machine learning by performing a convolution operation on a bias.

The ensemble machine learning unit 400 receives the water usage data labeled as ‘indoor water leak state’ and multidimensional data regarding water leak occurrence, and performs second machine learning by matching caliber-specific water leak occurrence and a water leak type.

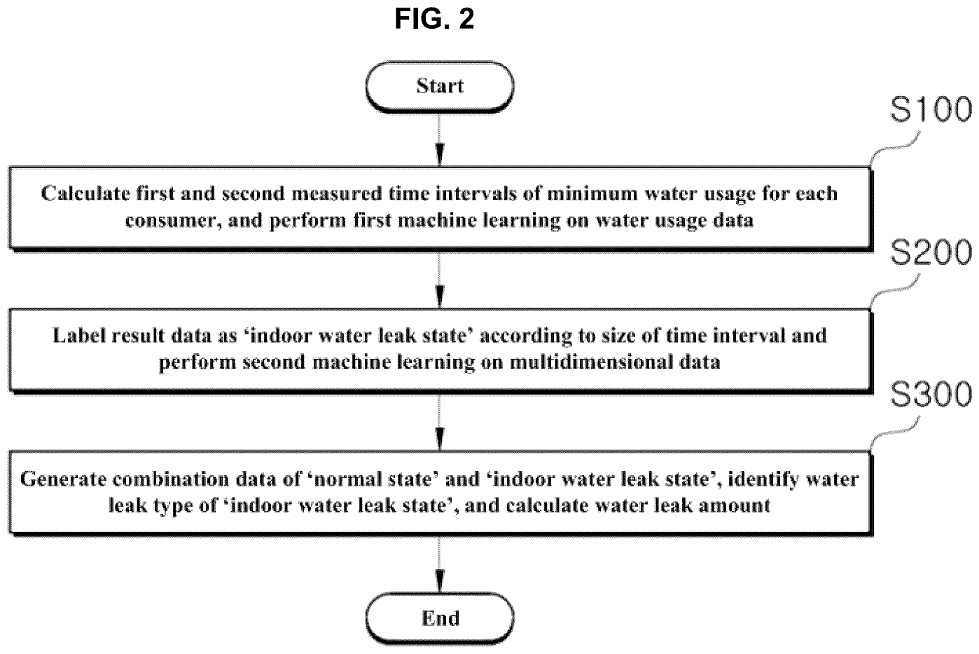

FIG. 2 is a flowchart for describing overall operations of an indoor water leak detection and type identification method using multidimensional data, according to an embodiment of the present disclosure.

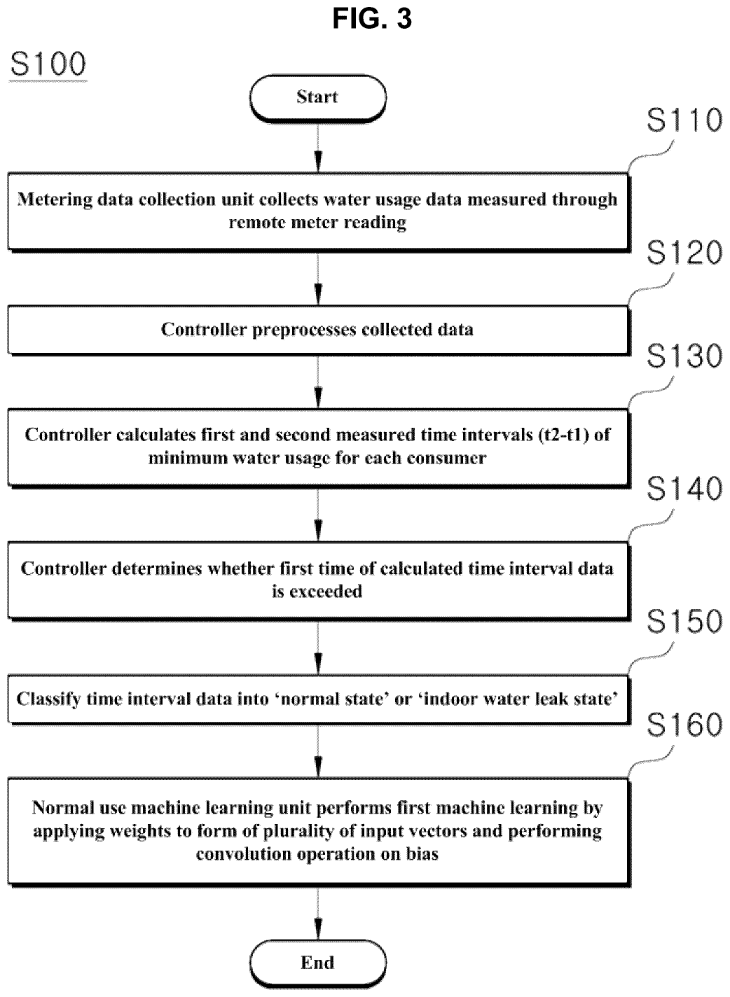

FIG. 3 is a flowchart for describing a detailed operation of step S100 of the indoor water leak detection and type identification method shown in FIG. 2.

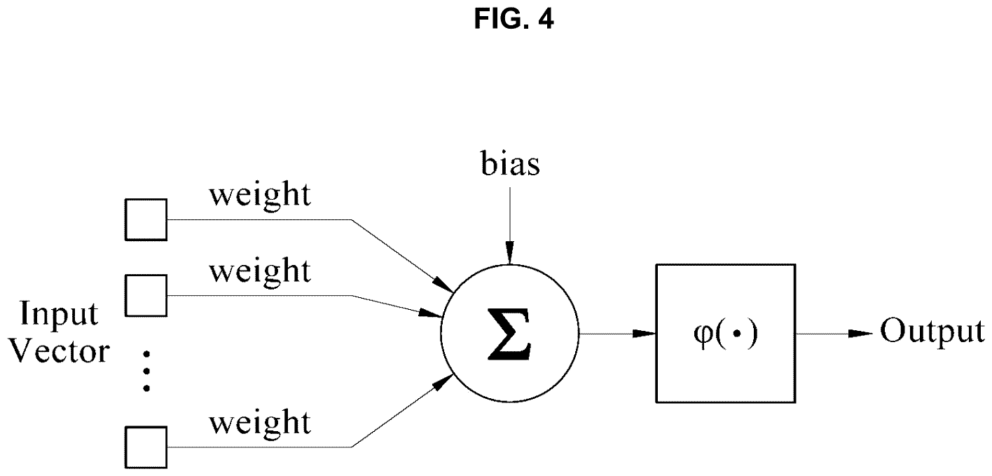

FIG. 4 is a configuration diagram for describing a detailed operation of step S130 of the indoor water leak detection and type identification method shown in FIG. 3.

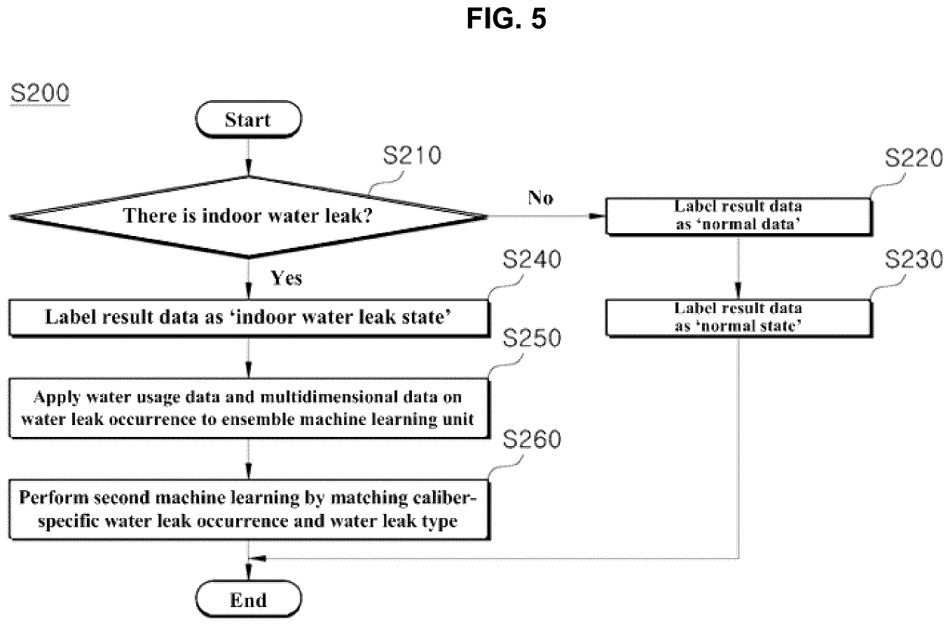

FIG. 5 is a flowchart for describing a detailed operation of step S200 of the indoor water leak detection and type identification method shown in FIG. 2.

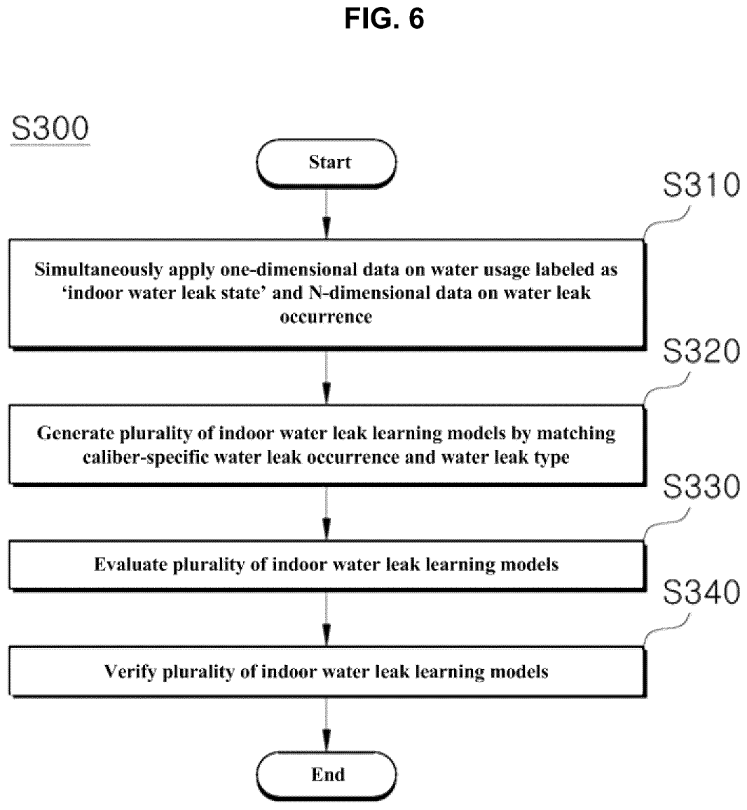

FIG. 6 is a flowchart for describing a detailed operation of step S260 of the indoor water leak detection and type identification method shown in FIG. 5.

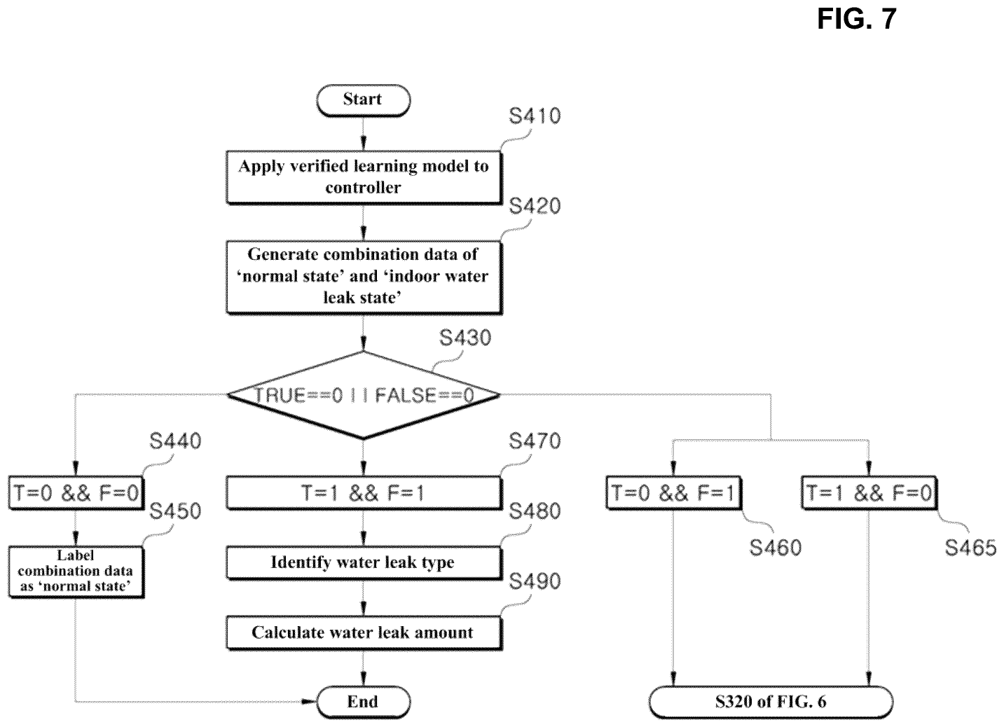

FIG. 7 is a flowchart for describing a detailed operation of step S300 of the indoor water leak detection and type identification method shown in FIG. 2.

The operations of an indoor water leak detection and type identification method using multidimensional data according to an embodiment of the present disclosure are briefly described with reference to FIGS. 1 to 7 as follows.

First of all, the controller 200 receives water usage data measured through remote meter reading, and calculates first and second measured time intervals of minimum water usage for each consumer. The normal use machine learning unit 300 performs first machine learning on water usage data (S100).

In other words, the metering data collection unit 100 collects water usage data measured from a water meter for remote meter reading (S110). The controller 200 receives the data collected from the metering data collection unit 100 and preprocesses the collected data (S120), and calculates first and second measured time intervals of minimum water usage for each consumer (S130).

Moreover, the controller 200 classifies the calculated time interval data into ‘normal state’ or ‘indoor water leak state’ (S150) by determining whether a first time of the calculated time interval data is exceeded (S140).

In the meantime, the normal use machine learning unit 300 receives the preprocessed data from the controller 200 in a form of a plurality of input vectors, and performs first machine learning in a time-series manner by applying weights and performing a convolution operation on the bias (S160), as shown in FIG. 4.

Next, the controller 200 receives result data, which is obtained by performing the first machine learning of the normal use machine learning unit 300, and then determines whether there is an indoor water leak (S210).

When it is determined that there is no indoor water leak, the controller 200 labels the result data as ‘normal data’ (S220), labels the result data as ‘normal state’ (S230), and terminates the operation.

On the other hand, when it is determined that there is an indoor water leak, the controller 200 labels the result data as ‘indoor water leak state’ and outputs the water usage data measured by a water meter for remote meter reading (S240). The ensemble machine learning unit 400 receives the water usage data labeled as ‘indoor water leak state’ and multidimensional data on water leak occurrence (S250), and performs second machine learning by matching caliber-specific water leak occurrence and a water leak type (S260).

Next, the controller 200 generates combination data of ‘normal state’ and ‘indoor water leak state’. When ‘indoor water leak state’ is detected, the controller 200 identifies water leak type and calculates water leak amount (S300).

In other words, the controller 200 receives the verified learning model (S410), and generates the combination data of ‘normal state’ and ‘indoor water leak state’ (S420). When ‘normal state’ is correctly detected (S440), the controller 200 labels the combination data as ‘normal state’ (S450) and ends the operation.

Furthermore, when ‘indoor water leak state’ is detected (S470), the controller 200 identifies the water leak type (S480) and calculates the water leak amount (S490).

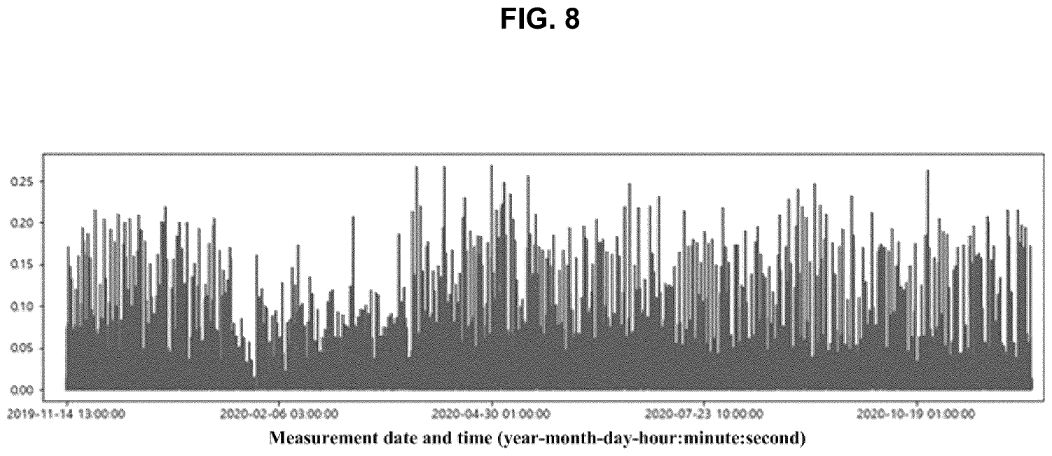

FIG. 8 is a graph according to a measurement date and time of water usage data collected by the metering data collection unit 100 in step S110 of the indoor water leak detection and type identification method shown in FIG. 3.

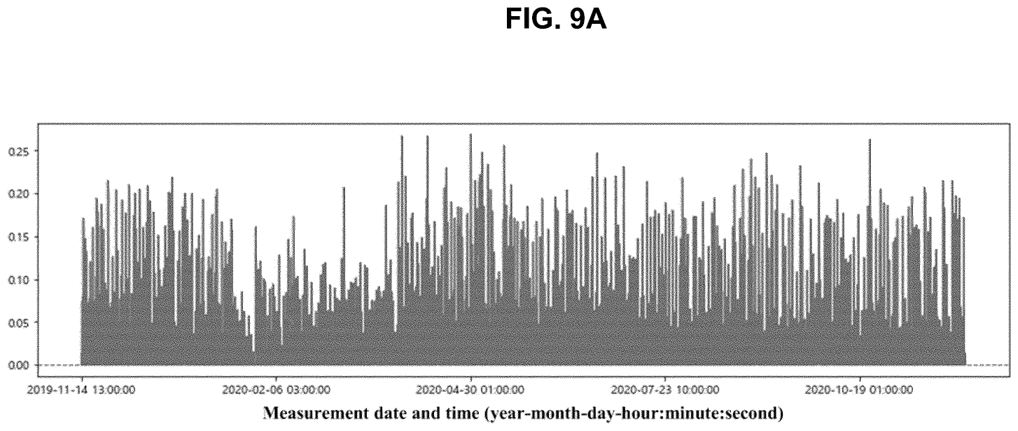

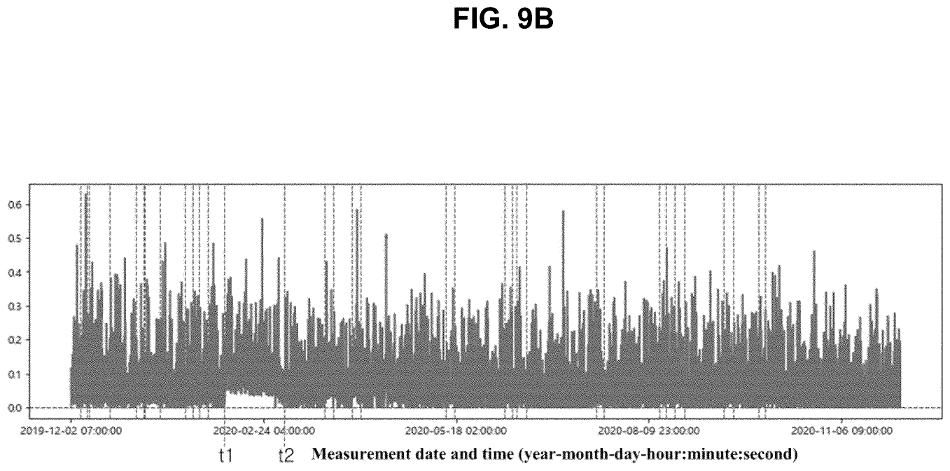

FIGS. 9A and 9B are graphs according to a measurement date and time of data (a) of normal state and data (b) of indoor water leak state classified by the controller 200 in step S150 of the indoor water leak detection and type identification method shown in FIG. 3.

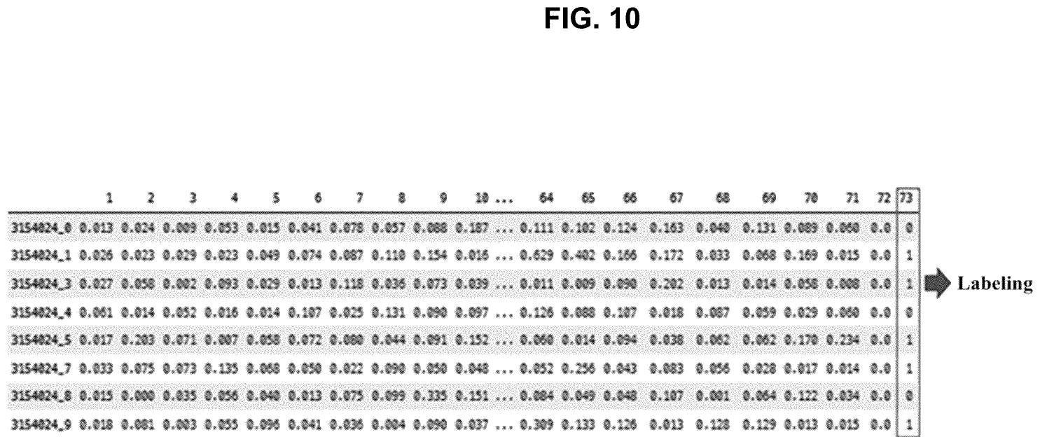

FIG. 10 is a table of data labeled according to whether there is an indoor water leak determined by the controller 200 in step S150 of the indoor water leak detection and type identification method shown in FIG. 5.

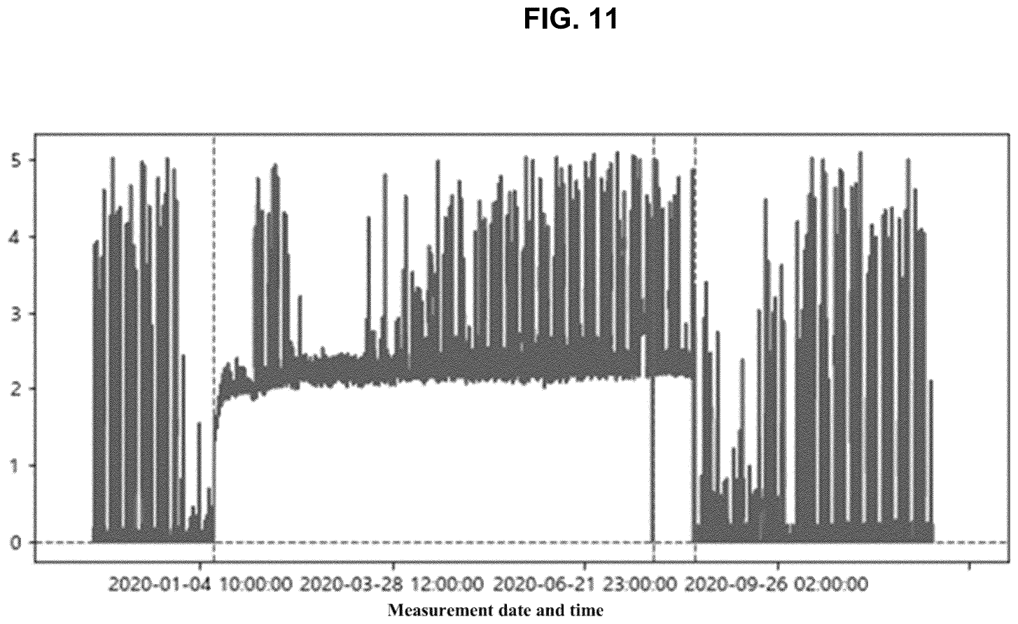

FIGS. 11 to 13 are graphs according to a measurement date and time of water usage data of water leak types classified by the controller 200 in step S300 of the indoor water leak detection and type identification method shown in FIG. 2.

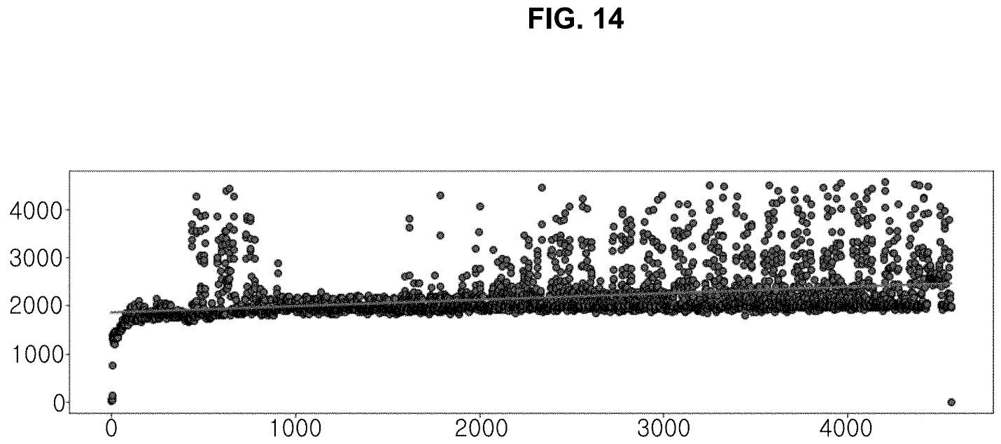

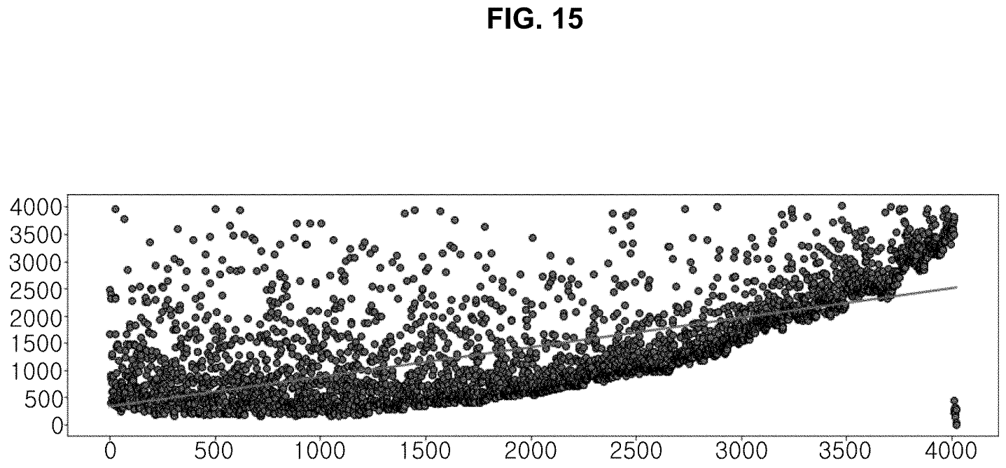

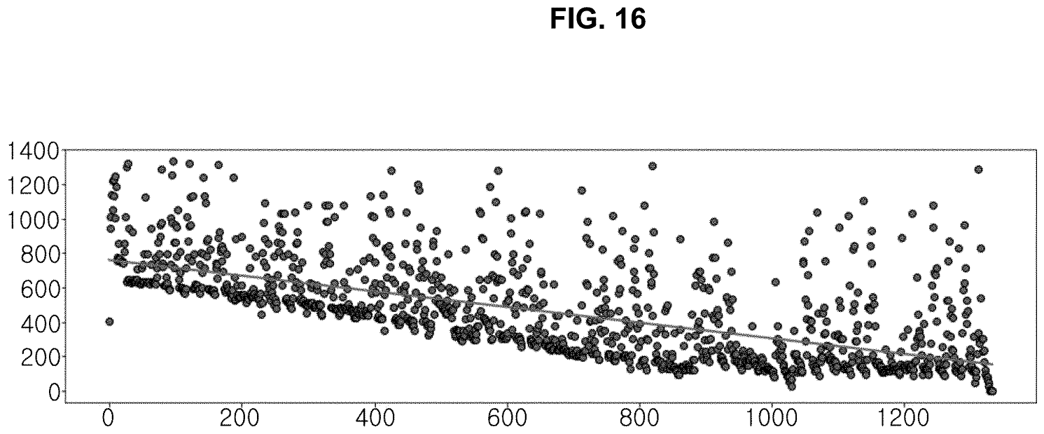

FIGS. 14 to 16 are graphs of water usage data compared to a water leak period of water leak types classified by a controller in step S300 of the indoor water leak detection and type identification method shown in FIG. 2, and correspond to cases where a slope of a trend line is horizontal (FIG. 14), positive (FIG. 15), or negative (FIG. 16).

The organic operations of an indoor water leak detection and type identification method using multidimensional data according to an embodiment of the present disclosure are described in detail with reference to FIGS. 1 to 16 as follows.

First of all, the metering data collection unit 100 collects water usage data, which is measured every hour from a water meter for remote meter reading in a form of a pattern image, as shown in FIG. 8.

Moreover, the collected raw data is merged, and a ‘groupby’ function is performed on the merged data for each customer number.

The controller 200 receives data collected from the metering data collection unit 100 and preprocesses a missing value, a negative value, and an abnormal value among the data.

In this case, the negative value refers to a value of backflow exceeding the maximum water usage set for each caliber. The abnormal value refers to a value that is not consistently filled on the graph of the measured water usage, but is instead empty in some areas. The controller 200 determines that these values are invalid data and removes them from a target of water leak detection and type identification.

As shown in FIG. 9B, the controller 200 calculates a time interval (t2−t1) in which after a minimum water usage Qmin is measured (first measurement) for each consumer, water usage increases and then the minimum water usage Qmin is measured (second measurement).

In this case, the time interval (t2−t1) is split based on the time when the meter reading value is recorded as ‘0’. When the meter reading value is not recorded as ‘0’ for the first hour (e.g. 72 hours), it is determined that a water leak is suspected to have occurred.

In other words, the controller 200 primarily classifies an image into ‘normal state’ shown in FIG. 9A or ‘indoor water leak state’ shown in FIG. 9B by determining whether the calculated time interval data exceeds the first time, and stores the classified result in a file format of csv or png.

In general, the minimum water usage Qmin is measured mainly at night. However, due to the prevalence of night activities in large cities, the time at which the minimum water usage Qmin is measured may be at a time other than night.

Afterwards, as shown in FIG. 4, the normal use machine learning unit 300 receives preprocessed data from a data preprocessor in a form of a plurality of input vectors to apply weights, performs a convolution operation on the bias, and performs first machine learning (i.e., deep learning and determination) on the result in a time-series method so as to be output.

In this case, the first machine learning uses a convolutional neural network and a long-short term memory (LSTM). The LSTM may be a type of recurrent neural network capable of being successfully trained even when the input sequence is long, and may remember inputs for a long time by continuously adding the inputs to a long-term memory.

In addition, the normal use machine learning unit 300 receives the image, which is primarily classified by the controller 200, evaluates and reclassifies the model by using a deep learning technique.

Data reclassified as being normal is determined as ‘normal state’ and is labeled as ‘0’, as shown in FIG. 10. The corresponding operation is terminated, and then is used as learning data.

In the meantime, the controller 200 receives result data, which is obtained by performing the first machine learning, from the normal use machine learning unit 300 and determines whether there is an indoor water leak. The controller 200 estimates data, which is reclassified as an indoor water leak, as ‘indoor water leak state’ and labels the data as ‘1’ as shown in FIG. 10.

Here, the controller 200 may also be called a processor, a controller, a microcontroller, a microprocessor, or a microcomputer, and may be implemented by hardware, firmware, software, or a combination thereof.

The ensemble machine learning unit 400 receives water usage data labeled as ‘indoor water leak state’ and multidimensional data (N-dimensional data vector) regarding water leak occurrence, and performs second machine learning by matching caliber-specific water leak occurrence and a water leak type.

In other words, the ensemble machine learning unit 400 simultaneously receives one-dimensional data on water usage labeled as ‘indoor water leak state’ and an N-dimensional data vector described later, and analyzes water leak periods in detail by applying supervised learning to the statistical characteristics of period-specific usage.

In this case, it is determined whether the actual water leak is predicted by the supervised learning model.

In other words, the accuracy of the learning model is improved by identifying a confusion matrix used in a machine learning technique such as a random forest algorithm and evaluating and verifying a supervised learning model.

In this case, the type of the created learning model includes types A to E.

For example, as shown in FIGS. 11 to 16, type A (FIG. 11) to type C (FIG. 16) may be classified into a toilet, a pipe rupture, and an anti-freezing faucet, respectively. Type D to Type E may be classified into a boiler, a water purifier, and a pot waterer, respectively.

Besides, as shown in FIGS. 14 to 16, the type of the created learning model may be identified through the slope of a regression line of water usage.

That is, referring to FIGS. 11 and 14, when the slope of the trend line of water usage within a water leak period is within ±0.2, the type of the learning model is classified as a toilet type.

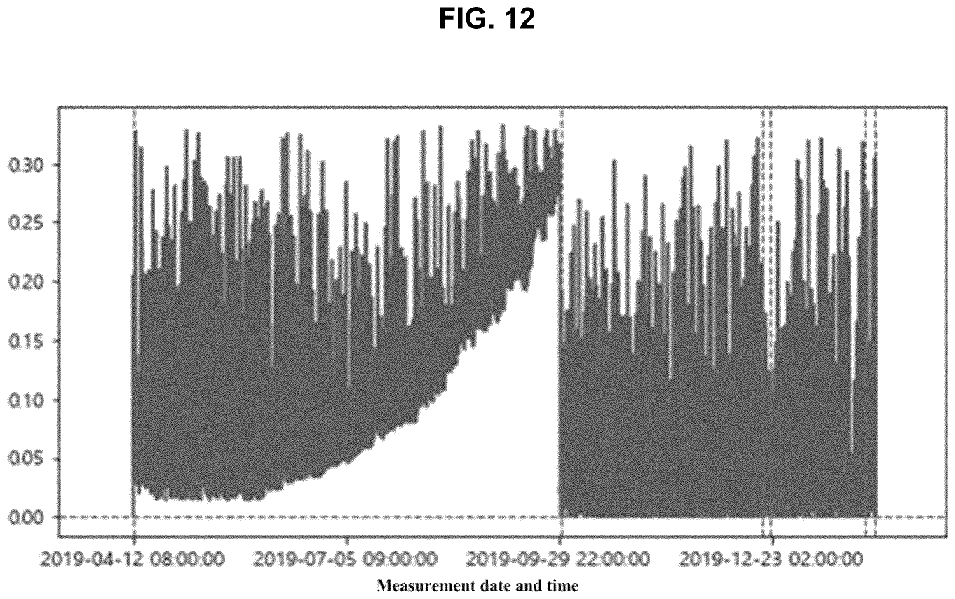

Also, referring to FIGS. 12 and 15, when the slope of the trend line of water usage within the water leak period is greater than or equal to 0.2, the type of the learning model is classified as a pipe rupture.

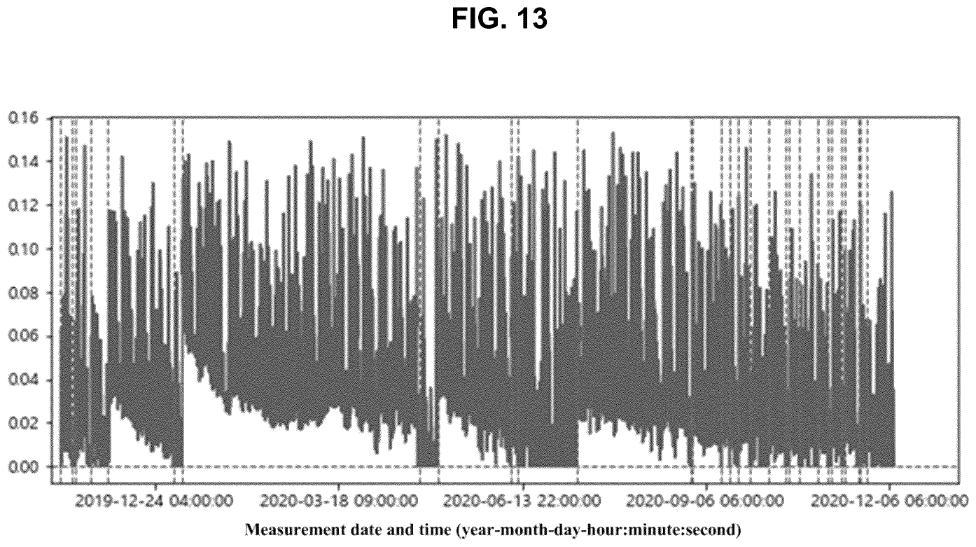

Likewise, referring to FIGS. 13 and 16, when the slope of the trend line of water usage within the water leak period is smaller than or equal to −0.2, the type of the learning model is classified as an anti-freezing faucet.

In this case, in a process of calculating the slope, an x-axis denotes a water leak period, and a y-axis denotes water usage. It is necessary to correct the scales of both axes to accurately calculate the slope.

The ensemble machine learning unit 400 receives the generated indoor water leak learning model to evaluate and verify the learning model.

As such, unlike the first machine learning process of the normal use machine learning unit 300 that trains one-dimensional data indicating consumer-specific water usage, the second machine learning process of the ensemble machine learning unit 400 trains not only consumer-specific water usage, but also N-dimensional data vectors such as a caliber, a cumulative meter reading value, and business identification.

In other words, the controller 200 receives data, which is evaluated and verified, from the ensemble machine learning unit 400 and generates combination data of ‘normal state’ and ‘indoor water leak state’.

For example, a case that ‘normal state’ is accurately detected is displayed as ‘T=0 && F=0’, and a case that ‘indoor water leak state’ is accurately detected is displayed as ‘T=1 && F=1’.

On the other hand, a first false positive case that ‘indoor water leak state’ is detected in spite of ‘normal state’ is displayed as ‘T=0 && F=1’. A second false positive case that ‘normal state’ is detected in spite of ‘indoor water leak state’ is displayed as ‘T=1 && F=0’.

When ‘normal state’ is accurately detected (T=0 && F=0) (S440), water usage data is labeled as ‘normal state’ (S450) and the operation is terminated.

Moreover, when the first and second false positives (T=0 && F=1, T=1 && F=0) (S460, S465), the controller 200 provides an N-dimensional data vector to the ensemble machine learning unit 400 and returns to step S320 in FIG. 6.

Accordingly, the ensemble machine learning unit 400 may receive the N-dimensional data vector from the controller 200 and may create, evaluate, and verify a plurality of learning models by matching caliber-specific water leak occurrence and water leak type by using a machine learning model.

In this case, the N-dimensional data vector includes a caliber, a cumulative meter reading value, business identification (commercial or domestic), year of construction, the type and diameter of a connected pipe, a label, civil complaint data (meter failure, water supply inconvenience, meter reading adjustment, maintenance, excessive water supply charges, or the like), facility data (a manufacturer, a size, year of burial, or meter information), and the like.

When ‘indoor water leak state’ is accurately detected (T=1 && F=1), an indoor water leak type is identified during a consumer's indoor water leak period by using a regression analysis technique through determining trends in water usage data to calculate a water leak amount.

As such, the accuracy of a normal water usage period and a water leak usage period may be improved by repeatedly performing error correction by applying supervised learning techniques and multivariate processing techniques.

For example, an embodiment of identifying water leak types is as follows.

Flow data and event data are received from a data distribution system. The flow data and the event data are patterned and stored in a big database.

Here, the event data includes the civil complaint data and the facility data in the N-dimensional data vector.

The controller 200 determines how much event data needs to be applied to perform training, and generates learning data obtained by organizing solutions found by using the flow data and the event data.

The learning data is data, which is preferentially accessed by the controller 200 before the controller 200 accesses the flow data and the event data in the future.

The ensemble machine learning unit 400 converts a data set stored in the big database into a learning data set and then creates a prediction model.

The controller 200 receives the converted learning data set from the ensemble machine learning unit 400 and converts the converted learning data set into an event type object of complex event processing (CEP).

The CEP engine calls the prediction model generated by the ensemble machine learning unit 400, and predicts indoor water usage at each location according to a predetermined prediction period.

Here, the CEP means extracting meaningful data in real time from events occurring from several event sources and performing corresponding functions.

The controller 200 receives the prediction model generated by the ensemble machine learning unit 400 and classifies various water leak types such as freezing and bursting, pipeline accidents, water pressure, ruptures, cracks, and pressure, but not limited to pipe damage in a pipe network.

As such, in a first false positive case that ‘indoor water leak state’ is detected in spite of ‘normal state’, and a second false positive case that ‘normal state’ is detected in spite of ‘indoor water leak state’, the present disclosure may accurately diagnose and predict false positives by using machine learning without a process of comparing values measured through various conventional sensors with reference values.

In the meantime, the controller 200 calculates the water leak amount by expressing the identified water leak type as a matching probability in conjunction with the ensemble machine learning unit 400.

In this case, a method of calculating the water leak amount may calculate an indoor water leak count and an indoor water leak amount by using the median or mode of water usage during a water leak period, the estimated water leak amount per hour, and a total water leak amount during the water leak period.

Moreover, the water leak amount is predicted based on indoor water usage at each location predicted by the CEP engine, and the water leak cost according to the water leak amount is calculated. Accordingly, the water leak cost may be deducted from the total water usage cost charged through the water meter.

As such, embodiments of the present disclosure provide an indoor water leak detection and type identification device using multidimensional data that may receive water usage data and multidimensional data regarding water leak occurrence and perform use machine learning to analyze an indoor water leak period in detail, and may repeatedly perform an error verification procedure to determine whether actual water leaks are predicted by a learning model, thereby improving the accuracy of indoor water leak detection and type identification, and a method thereof.

In this way, according to an embodiment of the present disclosure, false positives may be accurately diagnosed and predicted by using machine learning without a process of comparing values measured through various conventional sensors with reference values, when a normal state and an indoor water leak state are falsely detected.

Moreover, the accuracy of calculating a water leak period, a water leak count, a water leak type, and a water leak amount may be improved by repeatedly performing error correction by applying supervised learning techniques and multivariate processing techniques.

Steps or operations of the method or algorithm described with regard to an embodiment of the present disclosure may be implemented directly in hardware, may be implemented with a software module executable by hardware, or may be implemented by a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or a computer-readable recording medium well known in the art to which the present disclosure pertains.

Although an embodiment of the present disclosure are described with reference to the accompanying drawings, it will be understood by those skilled in the art to which the present disclosure pertains that the present disclosure may be carried out in other detailed forms without changing the scope and spirit or the essential features of the present disclosure. Therefore, the embodiments described above are provided by way of example in all aspects, and should be construed not to be restrictive.

According to an embodiment of the present disclosure, false positives may be accurately diagnosed and predicted by using machine learning without a process of comparing values measured through various conventional sensors with reference values, when a normal state and an indoor water leak state are falsely detected.

Moreover, the accuracy of calculating a water leak period, a water leak count, a water leak type, and a water leak amount may be improved by repeatedly performing error correction by applying supervised learning techniques and multivariate processing techniques.

Effects of the present disclosure are not limited to the effects mentioned above, and other effects not mentioned will be clearly understood by those skilled in the art from the following description.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. An indoor water leak detection and type identification device using multidimensional data, the device comprising:
a metering data collection unit configured to collect water usage data measured from a water meter for remote meter reading;
a controller configured to receive the measured water usage data, to calculate first and second measured time intervals of minimum water usage for each customer, to generate combination data of ‘normal state’ and ‘indoor water leak state’, and to perform identification of a water leak type and calculation of a water leak amount when the ‘indoor water leak state’ is detected;
a normal use machine learning unit configured to receive data preprocessed on the water usage data in a form of a plurality of input vectors, and to perform first machine learning by performing a convolution operation on a bias;
an ensemble machine learning unit configured to receive water usage data labeled as the ‘indoor water leak state’ and multidimensional data on water leak occurrence, and to perform second machine learning by matching caliber-specific water leak occurrence and the water leak type,
wherein the controller is configured to:
classify data on the calculated time intervals into the ‘normal state’ or the ‘indoor water leak state’ by determining whether a first time of the data on the calculated time intervals is exceeded;
preprocess a missing value, a negative value, and an abnormal value among the collected water usage data; and
remove the preprocessed missing value, the preprocessed negative value, and the preprocessed abnormal value from a water leak detection target and a type identification target,
wherein the water leak detection target includes a toilet, a pipe rupture, an anti-freezing faucet, a boiler, a water purifier, and a pot waterer,
wherein the ensemble machine learning unit classifies a type of a learning model by using a confusion matrix based on a random forest algorithm,
wherein the type of the learning model is classified into the toilet, the pipe rupture, the anti-freezing faucet, the boiler, the water purifier, and the pot waterer,
wherein the toilet, the pipe rupture, and the anti-freezing faucet are again classified through a slope of a trend line of water usage within a water leak period,
wherein the type of the learning model is classified as the toilet when the slope of the trend line is within ±0.2,
wherein the type of the learning model is classified as the pipe rupture when the slope of the trend line is greater than or equal to 0.2, and
wherein the type of the learning model is classified as the anti-freezing faucet when the slope of the trend line is smaller than or equal to 0.2.

2. The device of claim 1, wherein the metering data collection unit collects the water usage data measured from the water meter for remote meter reading,
wherein the controller receives and preprocesses the collected data,
wherein the controller calculates the first and second measured time intervals of the minimum water usage for each consumer,
wherein the controller determines whether the first time of the data on the calculated time intervals is exceeded,
wherein the controller classifies the data on the calculated time intervals as the ‘normal state’ or the ‘indoor water leak state’ based on whether the first time is exceeded, and
wherein the normal use machine learning unit receives the preprocessed data in the form of the plurality of input vectors, and performs the first machine learning in a time-series manner by performing the convolution operation on the bias.

3. The device of claim 1, wherein the controller receives result data, which is obtained by performing the first machine learning, and determines whether there is an indoor water leak,
wherein when it is determined that there is no indoor water leak, the controller labels the result data as ‘normal data’ and the ‘normal state’,
wherein when it is determined that the indoor water leak is present, the controller labels the result data as the ‘indoor water leak state’ and outputs the measured water usage data, and
wherein the ensemble machine learning unit receives the water usage data labeled as the ‘indoor water leak state’ and the multidimensional data on water leak occurrence, and performs the second machine learning by matching the caliber-specific water leak occurrence and the water leak type.

4. The device of claim 3, wherein the ensemble machine learning unit simultaneously receives one-dimensional data on the water usage labeled as the ‘indoor water leak state’ and the multidimensional data on water leak occurrence, and generates a plurality of indoor water leak learning models by the matching,
wherein the ensemble machine learning unit receives the generated plurality of indoor water leak learning models and evaluates the learning models, and
wherein the ensemble machine learning unit receives the evaluated plurality of indoor water leak learning models and verifies the learning models.

5. The device of claim 1, wherein the multidimensional data includes one or more of a caliber, a cumulative meter reading value, business identification, year of construction, a type and a diameter of a connected pipe, a label, civil complaint data, and facility data.

6. The device of claim 4, wherein the controller receives the verified learning models and generates the combination data of the ‘normal state’ and the ‘indoor water leak state’, labels the combination data as the ‘normal state’ and ends an operation when the ‘normal state’ is detected, and identifies the water leak type and calculates the water leak amount when the ‘indoor water leak state’ is detected.

7. The device of claim 6, wherein the controller displays a case that the ‘normal state’ is detected, as ‘T=0 && F=0’, as ‘T=0 && F=0’,
wherein the controller displays a case that the ‘indoor water leak state’ is detected, as ‘T=1 && F=1’,
wherein the controller displays a first false positive case that the ‘indoor water leak state’ is detected in spite of the ‘normal state’, as ‘T=0 && F=1’, and
wherein the controller displays a second false positive case that the ‘normal state’ is detected in spite of the ‘indoor water leak state’, as ‘T=1 && F=0’.

8. An indoor water leak detection and type identification method using multidimensional data, the method comprising:
receiving, by a controller of a device, water usage data measured through remote meter reading, calculating first and second measured time intervals of minimum water usage for each consumer, and performing, by a normal use machine learning unit, first machine learning on the water usage data;
labeling, by the controller, result data, which is obtained by performing the first machine learning, as ‘indoor water leak state’ in a case of water leak occurrence based on sizes of the calculated time intervals, receiving, by an ensemble machine learning unit, multidimensional data on the water leak occurrence, and performing second machine learning; and
generating, by the controller, combination data of ‘normal state’ and the ‘indoor water leak state’, and performing identification of a water leak type and calculation of a water leak amount when the ‘indoor water leak state’ is detected,
wherein the performing of the first machine learning includes:
calculating, by the controller, the first and second measured time intervals of the minimum water usage for each consumer;
determining, by the controller, whether the first time of data on the calculated time intervals is exceeded; and
classifying, by the controller, the data as the ‘normal state’ or the ‘indoor water leak state’ based on whether the first time is exceeded,
wherein the controller is configured to:
preprocess a missing value, a negative value, and an abnormal value among the collected water usage data; and
remove the preprocessed missing value, the preprocessed negative value, and the preprocessed abnormal value from a water leak detection target and a type identification target,
wherein the water leak detection target includes a toilet, a pipe rupture, an anti-freezing faucet, a boiler, a water purifier, and a pot waterer,
wherein the ensemble machine learning unit classifies a type of a learning model by using a confusion matrix based on a random forest algorithm,
wherein the type of the learning model is classified into the toilet, the pipe rupture, the anti-freezing faucet, the boiler, the water purifier, and the pot waterer,
wherein the toilet, the pipe rupture, and the anti-freezing faucet are again classified through a slope of a trend line of water usage within a water leak period,
wherein the type of the learning model is classified as the toilet when the slope of the trend line is within ±0.2,
wherein the type of the learning model is classified as the pipe rupture when the slope of the trend line is greater than or equal to 0.2, and
wherein the type of the learning model is classified as the anti-freezing faucet when the slope of the trend line is smaller than or equal to 0.2.

9. The method of claim 8, wherein the performing of the first machine learning includes:
collecting, by a metering data collection unit, the water usage data measured from a water meter for remote meter reading;
receiving and preprocessing, by the controller, the collected data;
calculating, by the controller, the first and second measured time intervals of the minimum water usage for each consumer;
determining, by the controller, whether the first time of the data on the calculated time intervals is exceeded;
classifying, by the controller, the data on the calculated time intervals as the ‘normal state’ or the ‘indoor water leak state’ based on whether the first time is exceeded; and
receiving, by the normal use machine learning unit, the preprocessed data in the form of the plurality of input vectors, and performing the first machine learning in a time-series manner by performing the convolution operation on the bias.

10. The method of claim 8, wherein the performing of the second machine learning includes:
receiving, by the controller, result data, which is obtained by performing the first machine learning, and determining whether there is an indoor water leak;
labeling the result data as ‘normal data’ and the ‘normal state’ when it is determined that there is no indoor water leak, and labeling the result data as the ‘indoor water leak state’ and outputting the measured water usage data when it is determined that the indoor water leak is present; and
receiving, by the ensemble machine learning unit, the water usage data labeled as the ‘indoor water leak state’ and the multidimensional data on water leak occurrence, and performing the second machine learning by matching the caliber-specific water leak occurrence and the water leak type.

11. The method of claim 10, wherein the performing of the second machine learning includes:
simultaneously receiving, by the ensemble machine learning unit, one-dimensional data on the water usage labeled as the ‘indoor water leak state’ and the multidimensional data on water leak occurrence, and generating a plurality of indoor water leak learning models by the matching;
receiving, by the ensemble machine learning unit, the generated plurality of indoor water leak learning models and evaluating the learning models; and
receiving, by the ensemble machine learning unit, the evaluated plurality of indoor water leak learning models and verifying the learning models.

12. The method of claim 8, wherein the multidimensional data includes one or more of a caliber, a cumulative meter reading value, business identification, year of construction, a type and a diameter of a connected pipe, a label, civil complaint data, and facility data.

13. The method of claim 11, wherein the performing of the identification of the water leak type and the calculation of the water leak amount includes:
receiving, by the controller, the verified learning models and generating the combination data of the ‘normal state’ and the ‘indoor water leak state’;
labeling the combination data as the ‘normal state’ and ending an operation when the ‘normal state’ is detected; and
identifying the water leak type and calculating the water leak amount when the ‘indoor water leak state’ is detected.

14. The method of claim 13, wherein the generating of the combination data includes:
displaying, by the controller, a case that the ‘normal state’ is detected, as ‘T=0 && F=0’;
displaying, by the controller, a case that the ‘indoor water leak state’ is detected, as ‘T=1 && F=1’;
displaying, by the controller, a first false positive case that the ‘indoor water leak state’ is detected in spite of the ‘normal state’, as ‘T=0 && F=1’; and
displaying, by the controller, a second false positive case that the ‘normal state’ is detected in spite of the ‘indoor water leak state’, as ‘T=1 && F=0’.
